(19) United States
(12) Patent Application Publication
(10) Pub. No.: US 2006/0092818 A1
(43) Pub. Date: May 4, 2006

(54) Multiple format compact disk

(76) Inventor: Caio Anderson Almelda, Round Lake Beach, IL (US)

Correspondence Address: Steven Thrasher, 391 Sandhill Dr., Richardson, TX, 75080, US

(21) Appl. No.: 10/980,548

(22) Filed: Nov. 3, 2004

(51) Int. Cl. G11B 7/24

(52) U.S. Cl. 369/275.1

(57) ABSTRACT

The invention teaches a compact disk (CD) that is adapted to accommodate multiple CD standards. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims.

### TECHNICAL FIELD OF THE INVENTION

The invention relates generally to compact disks.

### PROBLEM STATEMENT

Interpretation Considerations

This section describes the technical field in more detail, and discusses problems encountered in the technical field. This section does not describe prior art as defined for purposes of anticipation or obviousness under 35 U.S.C. section 102 or 35 U.S.C. section 103. Thus, nothing stated in the Problem Statement is to be construed as prior art.

Discussion

Compact disks are easily recognized by most persons as reliable, durable, and application-flexible memory storage devices. FIG. 1 (prior art) illustrates one embodiment of a common compact disk, which is typically made of a polycarbonate plastic substrate covered by a thin aluminum layer that is in-turn covered by a layer of acrylic. Functionally, compact disks spin so that a laser can read a continuous spiral of data. The data is typically embodied as bumps in the acrylic layer, in a manner known in the compact disk art (bumps are sometimes called “pits,” depending on the perspective of the viewer).

The bumps on a compact disk are organized according to standards (and file systems) to define data. Much like the rules of grammar, standards are rules that define bump and data organization so that a machine designed according to one or more related standards can read the data on the compact disk in a predictable manner.

Compact disk standards are well known in the compact disk arts, and include: red book, yellow book, green book, orange book, white book, blue book, purple book, CD-I, Photo CD, CD-ROM XA, and a host of other standards. Standards are often application-type specific, which stems in part from the fact that error checking is much more important for data storage than it is for audio replay. However, one result of using different method of storing data is that most standards are not compatible.

In other words, for example, most audio-playing machines do not read data. An audio playing machine can only read data if it contains additional mechanical and electronic components needed to the read additional data standards. However, such machines are bulky, expensive, use substantial power, generate considerable heat, and often have shorter life spans. In addition, although each machine that incorporates multiple standards can read different disks, these machines read only one disk at a time. Accordingly, there is a need for systems, methods, and devices that give users the data storage advantages of compact disks, while accommodating multiple types of compact disk reading machines.

### BRIEF DESCRIPTION OF THE DRAWINGS

Various aspects of the invention, as well as an embodiment, are better understood by reference to the following detailed description. To better understand the invention, the detailed description should be read in conjunction with the drawings in which:

FIG. 1 (prior art) illustrates one embodiment of a common compact disk.

FIG. 2 illustrates a compact disc incorporating the features of the invention.

FIGS. 3a and 3b illustrate a hypothetical spiral of information that is “unspun” to show the location of different sectors of information linearly.

FIG. 4 is a block flow diagram of a formatting algorithm.

FIG. 5 is block flow diagram of an information storage algorithm.

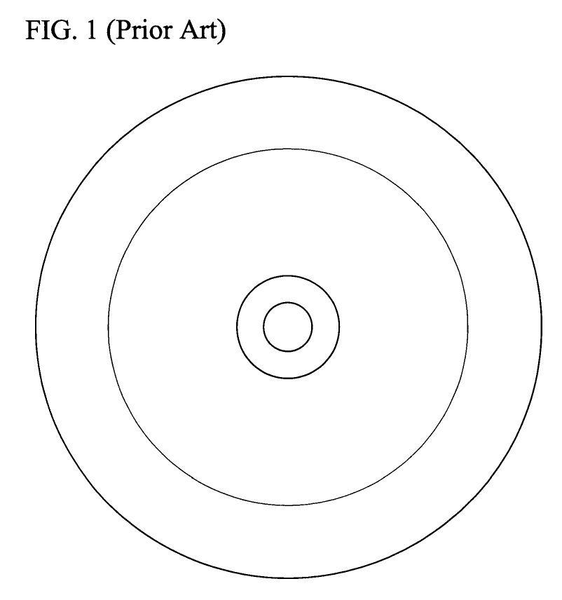

### EXEMPLARY EMBODIMENT OF A BEST MODE

Interpretation Considerations

When reading this section (An Exemplary Embodiment of a Best Mode, which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”).

Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for—functioning—” or “step for—functioning—” in the Claims section. Sixth, the invention is also described in view of the Festo decisions, and, in that regard, the claims and the invention incorporate equivalents known, unknown, foreseeable, and unforeseeable. Seventh, the language and each word used in the invention should be given the ordinary interpretation of the language and the word, unless indicated otherwise.

Some methods of the invention may be practiced by placing the invention on a computer-readable medium. Computer-readable mediums include passive data storage, such as a random access memory (RAM) as well as semi-permanent data storage such as a compact disk read only memory (CD-ROM). In addition, the invention may be embodied in the RAM of a computer and effectively transform a standard computer into a new specific computing machine.

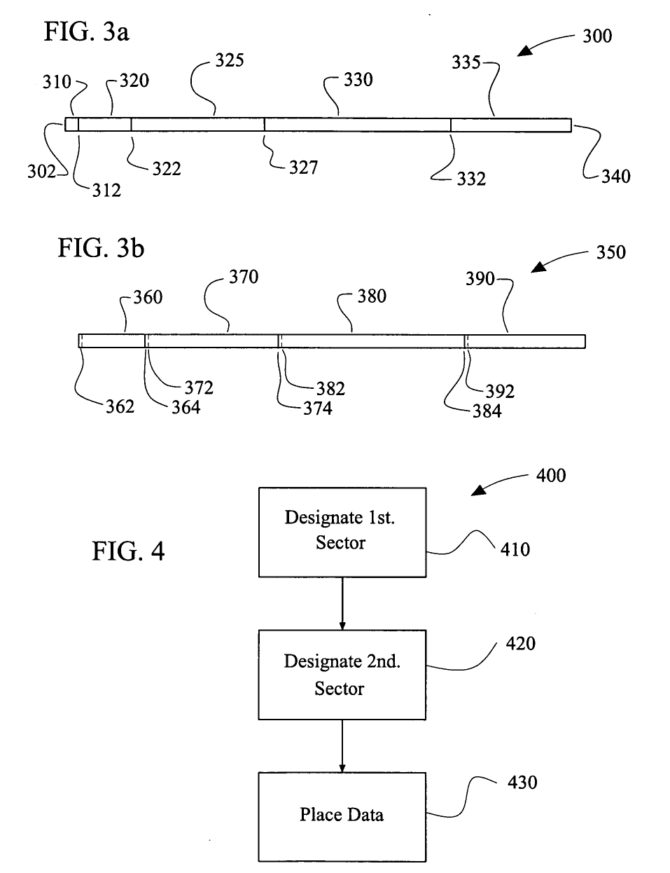

Data elements are organizations of data. One data element could be a simple electric signal placed on a data cable. One common and more sophisticated data element is called a packet. Other data elements could include packets with additional headers/footers/flags. Exemplary headers include the headers discussed and shown in FIGS. 3a and 3b (see below). Data signals comprise data, and are carried across transmission mediums and store and transport various data structures, and, thus, may be used to transport the invention. It should be noted in the following discussion that acts with like names are performed in like manners, unless otherwise stated.

Of course, the foregoing discussions and definitions are provided for clarification purposes and are not limiting. Words and phrases are to be given their ordinary plain meaning unless indicated otherwise.

Description of the Drawings

One result of using different method of storing data is that most standards are not compatible. Thus, to play disks of different standards, one must either use different machines, or a use a class of multi-standard machines that are bulky, expensive, use substantial power, generate considerable heat, and are more prone to breakdowns. However, this poses the additional issue of data/voice/video being stored in least-efficient formats. For example, if one wishes to store the same amount of audio at the same quality as would be stored in an audio standard, it would take a much larger amount of data, and thus a much larger surface area of a compact disk. The result is that to store audio in a data format, one cannot store as much playtime. However, if one wishes to bundle audio with quality data (some very limited data can be transmitted via the audio standards), they are limited to using a data standard.

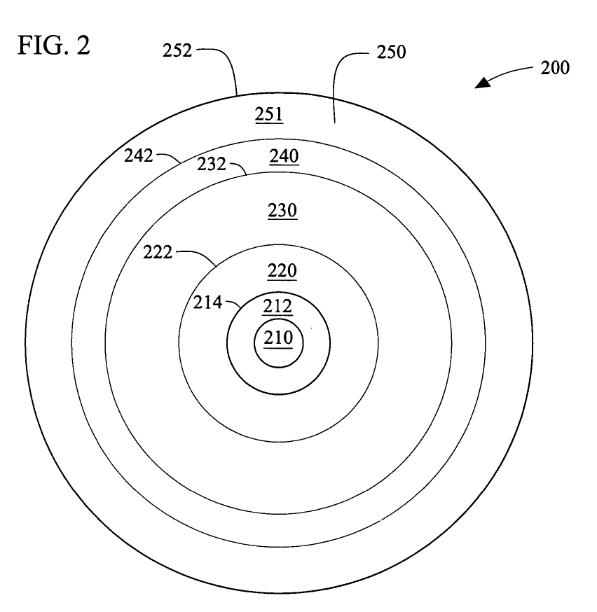

FIG. 2 illustrates a compact disc 200 incorporating the features of the invention. From FIG. 2, one can see the compact disc surface 250 which extends from an edge 252 to a center hole 210. The CD surface 250 includes an area of information comprised of sectors 220, 230, 240, which comprises the area from a beginning of information 214 to an edge of the third sector 242. The disc surface 250 also includes non-informational areas 251 and 212.

The area of information shown in FIG. 2 is segmented into three sectors 220, 230, 240. A first sector 220 extends from the beginning of information 214 to a first pit of silence 222, the second sector 230 extends from the first pit of silence 222 to the second pit of silence 232 and the third sector 240 extends from the second pit of silence 232 to the edge of the third sector 242. Of course, it should be understood that although three sectors are shown in FIG. 2, the area of information may be sub divided into any number of a plurality of sectors, each segmented from the other by a pit of silence 222, 232. In addition, although each pit of silence 222, 232 is illustrated as being circular and encompassing a least a full rotation of the compact disc, it should be understood that a pit of silence is defined by a data pattern, and not by a circular portion of the compact disc surface per say. Accordingly, a pit of silence may comprise a portion of a compact disc rotation, a full rotation of a compact disc, or multiple rotations of a compact disc.

If a video standard is used at all on the compact disk, it is preferred that the interior most sector (or sectors where more than one video track is present) comprise a video standard. If the compact disc does not have a video standard, then the interior most sector should be an audio standard if an audio standard exist on the compact disc. Accordingly, the first sector or grouping of common-standard sectors should comprise a first standard preference being a video standard.

The next sector or grouping of common-standard sectors should comprise a second standard preference being an audio standard. The third sector or grouping of common-standard sectors should be a third standard preference being a data standard. Of course, multiple video standards or sectors may be separated one from another by using pits of silence, multiple audio standards or sectors may be separated one from another by using pits of silence, and multiple data standards or sectors may be separated one from another by using pits of silence. Accordingly, sectors are ordered from interior to exterior based on standard types, with video standards having a highest priority, audio standards having the next highest priority, and data standards having the lowest priority.

Furthermore, will be appreciated by one of ordinary skill in the art that the information existing on a compact disc sits on the compact disc as a single spiral of information, much like a record player has a single spiral track that a record player needle uses to generate sound in a record player. Preferably, the first sector 220 also includes an auto-run file, as well as an interface projector.

FIGS. 3a and 3b illustrate a hypothetical spiral of information that is “unspun” to represent the location of different sectors of information linearly. A first spiral of information 300 includes the information maintained on a compact disc, from a beginning of information 302 located near the center of a compact disc and spiraling outward to an end of information 340. The information comprises a first sector 320, a second sector 325, a third sector 330, and a fourth sector 335. Each sector 320, 325, 330, 335, is separated one from the other by pits of silence 312, 322, 327, and 332. The first spiral of information 300 also comprises an identification header 310 located between the beginning of information 302 and the first sector 320. The identification header 310 comprises compact disc machine-readable data that identifies the information type associated with each sector.

For example, the identification header 310 may maintain information that identifies the first sector 320 as a video sector, the second sector 325 has having an audio standard, the third sector 330 has having a second audio standard, and the fourth sector 335 has having a data standard. In addition to identifying the type of standard maintained by each sector, the identification header 310 may also comprise information regarding the physical location of each sector along the first spiral of information 300. For example, the identification header 310 may maintain information identifying the video sector as beginning at the first pit of silence 312, and ending at the second pit of silence 322. The identification header 310 may also identify that the second sector 325 begins at the second pit of silence 322 and ends at the third pit of silence 327, that the third sector 330 begins at the third pit of silence 327 and ends at the fourth pit of silence 332, and that the fourth sector begins at the fourth pit of silence 332 and concludes at the end of information 340. The identification header 310 may also maintain information such as the title of each sector, length of each sector, and other substantive information about the sector.

Similarly FIG. 3b illustrates a second spiral of information 350. Similar to the first spiral of information 300, the second spiral of information has a first sector 360 of video, a second sector 370 of audio, a third sector 380 comprising a first data standard, and a fourth sector 390 comprising a second data standard. The second spiral of information comprises information from a beginning of information 352 to an end of information 392, and includes pits of silence 364, 374, and 384. Pits of silence will be identified by most compact disc machines as divisions between sectors (sometimes called tracks), such as the division between songs on an audio compact disc. The second spiral of information includes a plurality of identification headers at the beginning of the information and at the beginning of each track and extending to the dashed vertical line immediately to the right thereof. Each identification header 362, 372, 382, and 392 includes information analogous to the identification header 310, such as information regarding the standard associated with that sector, as well as other information about the sector such as where physically along the second spiral of information that sector ends.

Accordingly, for example, the first identification header 362 identifies the first sector 360 as a video sector that terminates at the first pit of silence 364. The second identification header 372 begins after the first pit of silence 364 and continues into the second sector sufficient to provide the relevant information about the second sector, such as that the second sector is an audio standard, and ends at the second pit of silence 374. Similarly, the third identification header 382 is configured to provide information about the third sector 380, and the fourth identification header 392 as configured to provide information about the fourth sector 390. Of course, it should be understood that each identification header may comprise additional information, such as author, title, date, name, inscriptive identifiers, or other information as designed by the creator of that header.

FIG. 4 is a block flow diagram of a formatting algorithm 400. The formatting algorithm 400 begins with a designate first sector act 410. In the first designate sector act 410 an area of information, which may be embodied physically as a continuous length of information along an information spiral, is sized and designated for a first information type, and first information standard. Then, in a designate second sector act 420, a second sector is identified and associated with an area of information, or a length of the information spiral. In addition, the second sector is associated with a second information type, and second information standard. Then, the formatting algorithm 400 proceeds to a place information act 430 in which the first sector and the second sector are placed on a compact disc and separated one from the other by a pit of silence. Preferably, the first sector is the interior most sector of the compact disc, and is selected based on standard-type priority, with video information receiving the highest priority and the interior-most position, then audio information receiving the next-highest priority and receiving the next-most-interior position, then and data information receiving the lowest priority, and occupying the outermost position.

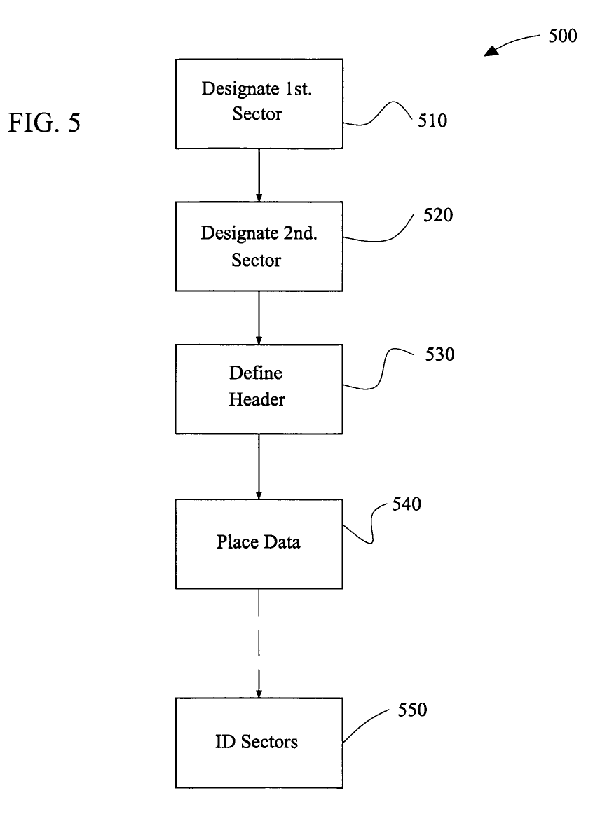

FIG. 5 is block flow diagram of an information storage algorithm 500. The information storage algorithm 500 begins in a designate first sector act 510, and then proceeds to a designate second sector at 520. Next, the information storage algorithm in a defined header act 530 encodes information for an identification header. For example, information regarding a sectors standard, size, author, length, time of play, or other information may be encoded in the information header. Then, also part of the define header act 530, the header is either allocated for placement at the beginning of the first sector of the compact disc, or is designated for location on the compact disc at the beginning of a sector on the compact disc.

After sectors have been designated and the header(s) have been defined, the information is placed on a compact disc in a place information act 540. Following the placement of information on the compact disc the information storage algorithm 500 proceeds along dash lines to an ID sectors act 550. The dash lines in FIG. 5 indicate that the identification of sectors in the ID sectors act 550 need not follow immediately after the place information act 540 and that the ID sectors act 550 may be accomplish after or during the placing of information act 540. In the ID sectors act 550, the sectors that are compatible with and playable by a machine that is adapted to read at least at one compact disc standard are identified. In one embodiment, user then may select which sectors (or tracks) that he or she wishes to play or review. Sometimes, a machine may not be able to read each sector because the machine may not have the capability of understanding each standard associated with each sector. In such a case, the machine need only display information regarding the sectors that it does have the ability to read and play.

Exemplary Implementation

The invention finds particular utility in a Karaoke embodiment. Karaoke is a party and nightclub pastime where persons sing over a track, which typically does not include a lead vocal track. A preferred karaoke embodiment incorporates a video first sector, an audio second sector, and a data third sector. Preferably the audio is separated into two channels, and each channel may be associated with a different sector. These sectors may be right and left channels, but are preferably a lead vocal sector, and a sector having all other sound. Accordingly, a karaoke machine may be configured to play audio with or without a lead vocal track.

In addition, a video sector may also be configured with two channels to store and play audio, thus negating the need for a completely separate audio sector (however, the use of a separate audio sector may provide higher quality audio, when desired). In one embodiment separate audio may be associated with a left channel and a right channel, such that the audio with the lead vocals may be associated with one of the channels, and audio without the lead vocals may be associated with the other channel. The use of a separate data sector can be used to provide a redundant delivery means for a karaoke production, and/or as a means for providing data-type presentations. For example, the data may provide photos of the artist(s), pictures, sing-along bulletins (common for church sing-along praise services), and Internet screen-connections.

Of course, it should be understood that the order of the acts of the algorithms discussed herein may be accomplished in different orders depending on the preferences of those skilled in the art, and such acts may be accomplished as software. Furthermore, though the invention has been described with respect to a specific preferred embodiment, many variations and modifications will become apparent to those skilled in the art upon reading the present application. It is therefore the intention that the appended claims and their equivalents be interpreted as broadly as possible in view of the prior art to include all such variations and modifications.

I claim:

1. A memory storage device, comprising:
a compact disk comprising
a first sector in a first standard;
a second sector in a second standard; and
a pit of silence separating the first sector from the second sector.

2. The device of claim 1 wherein the first standard is an video standard.

3. The device of claim 1 wherein the second standard is a data standard.

4. The device of claim 1 wherein the second standard is a audio standard.

5. The device of claim 1 further comprising a third sector having a third standard and a second pit of silence separating the third sector from the second sector.

6. The device of claim 1 wherein the first sector is the sector located nearest to a compact disk center, and the first sector is a video sector.

7. The device of claim 1 wherein the first sector is the sector located nearest to a center of the compact disk, and the first sector is an audio sector.

8. The device of claim 1 wherein the sector located farthest from a center of the compact disk comprises a data standard.

9. The device of claim 8 wherein the sector comprises an auto RUN file.

10. The device of claim 8 wherein the sector comprises an interface projector.

11. A method of formatting a memory storage device, comprising:
designating a sector size for a first data type;
designating a sector size for a second data type; and
placing data on a compact disk such that there is a first sector for the first data type, a second sector for the second data type, and a pit of silence that separates the first sector from the second sector.

12. The method of claim 11 wherein the first data type comprises a first standard.

13. The method of claim 12 wherein the second data type comprises a second standard.

14. The method of claim 11 further comprising defining an identification header as compact disk readable data that identifies the data type associated with each sector, the identification header being located on the compact disk at the beginning of the centermost sector of the compact disk.

15. The method of claim 11 further comprising defining an identification header as compact disk readable data that identifies a data type associated with a sector, the identification header being located on the compact disk at the beginning of a sector of the compact disk.

16. The method of claim 11 wherein the first sector comprises a first track.

17. The method of claim 11 wherein the first sector comprises a video standard.

18. The method of claim 17 wherein the second sector comprises a data standard.

19. The method of claim 11 further comprising identifying the sectors that are compatible with and playable on a machine that is adapted to read at least one compact disk standard, wherein the machine is not adapted to read each standard present on the compact disk.

20. A specific computing device that enables a compact disk to carry multiple compact disk standards, by sequentially:
identifying a sector size for a first data type comprising a first standard;
identifying a sector size for a second data type comprising a second standard, the second standard being a data standard;
defining an identification header as compact disk readable data that identifies a data type associated with a sector, the identification header being located on the compact disk at the beginning of a sector of the compact disk; and
placing data on a compact disk such that there is a first sector for the first data type, a second sector for the second data type, and a pit of silence that separates the first sector from the second sector.
